(19) United States
(12) Patent Application Publication
(10) Pub. No.: US 2026/0045857 A1
(43) Pub. Date: Feb. 12, 2026

(54) HEAT EXCHANGERS FOR ELECTRIC MACHINES AND RELATED METHODS OF OPERATION

(71) Applicants: MITSUBISHI HEAVY INDUSTRIES, LTD., Tokyo (JP); MASSACHUSETTS INSTITUTE OF TECHNOLOGY, Cambridge, MA (US)

(72) Inventors: Koichiro IIDA, Tokyo (JP); Mikito SASAKI, Tokyo (JP); Masahiko EZUMI, Tokyo (JP); Zoltan SPAKOVSZKY, Cambridge, MA (US); Marc AMATO, Saunderstown, RI (US); Henry ANDERSEN, Berkeley, CA (US); YuanKang CHEN, Sizba (SG); Zachary CORDERO, Houston, TX (US); Aidan DOWDLE, Arlington, MA (US); Edward GREITZER, Wayland, MA (US); David GONZALEZ CUADRADO, Watertown, MA (US); Charlotte GUMP, Cambridge, MA (US); James KIRTLEY, Brookline, MA (US); Jeffrey LANG, Sudbury, MA (US); David OTTEN, Newton, MA (US); David PERREAULT, Brookline, MA (US); Mohammad QASIM, Cambridge, MA (US)

(73) Assignees: MITSUBISHI HEAVY INDUSTRIES, LTD., Tokyo (JP); MASSACHUSETTS INSTITUTE OF TECHNOLOGY, Cambridge, MA (US)

(21) Appl. No.: 19/102,784

(22) PCT Filed: Jul. 26, 2023
(86) PCT No.: PCT/JP2023/027468

§ 371 Date: Feb. 10, 2025

Related U.S. Application Data
(60) Provisional application No. 63/397,376, filed on Aug. 11, 2022.

(51) Int. Cl. H02K 9/22; H02K 1/16; H02K 9/10

(52) U.S. Cl. CPC H02K 9/227; H02K 1/16; H02K 9/10

(57) ABSTRACT

Electric machines and related methods are generally described. In some embodiments, an electric machine may be integrated with a thermal management system for high specific power output performance. The construction and operational parameters of the systems may be 5 precisely designed to achieve high specific power outputs between 10 kW/kg and 25 KW/kg. The thermal management system may include a heat exchanger integrated directly into the electric machine for enhanced thermal transport out of the system. A fluid (e.g., air) may flow through various flow paths throughout the system to increase cooling of the system.

### TECHNICAL FIELD

The technology is generally related to electric machine systems and related methods. More specifically, systems and methods designed to maximize specific power performance while reducing systemic losses are described in some embodiments.

### BACKGROUND ART

For more than a century, electric machines have been used to power and drive the modern world. Electric machines typically include a rotor electromagnetically coupled to a stator. The rotor is typically rotatable about the stationary stator. In some instances, electric machines operate as generators, converting mechanical energy into electrical energy, employing the principle of electromagnetic induction. Sources of mechanical energy include steam turbines, gas turbines, internal combustion engines, and wind turbines, among others. In other instances, electric machines operate as motors, converting electrical energy into mechanical energy. Motors are employed in a broad variety of applications, including fans, machine tools, turbines, compressors, heating, ventilation, and air conditioning (HVAC) systems, motor vehicles, and many others.

### SUMMARY OF INVENTION

In some embodiments, a system includes an electric machine including a rotor comprising a plurality of magnets arranged in a Halbach array, and a stator electromagnetically coupled to the rotor. In some embodiments, the system may also include a plurality of power electronics arranged in a toroidal configuration around a longitudinal axis of the stator, and wherein the plurality of power electronics are close-coupled to the stator, and a thermal management system in thermal communication with the electric machine, wherein the thermal management system is configured to flow a cooling fluid through a portion of the system in a first direction, wherein the thermal management system comprises at least one flange configured to redirect the cooling fluid from the first direction to a s second direction, and wherein a specific power of the system is between 10 kW/kg and 20 kW/kg during operation.

In some embodiments, a system includes an electric machine including a rotor, a stator comprising a plurality of magnets arranged in a Halbach array, wherein the stator comprises a plurality of pole pairs, and a plurality of power electronics, wherein each of the plurality of pole pairs of the stator is associated with separate three single-phase bridge inverters of the power electronics, wherein the rotor is configured to rotate at least at 190 m/s relative to the stator, wherein an electromagnetic shear stress between the rotor and the stator is greater than 35 kPa during operation, wherein an electromagnetic loading factor of the system is between 0.25 and 0.35 during operation, and wherein a specific power of the system is between 10 kW/kg and 20 kW/kg during operation.

In some embodiments, a system may include a frame, a stator, a rotor electro magnetically coupled to the stator, the stator disposed at least partially within the rotor, and a heat exchanger operatively coupling the stator with the frame, w herein the heat exchanger maintains the stator substantially stationary relative to the frame, and wherein the heat exchanger is in thermal communication with the stator.

In some embodiments, a method of operating an electric machine includes maintaining a stator substantially stationary relative to a frame with a heat exchanger, the heat exchanger operatively coupled to the stator, the heat exchanger operatively coupled to the frame, and transporting thermal energy from the stator to the heat exchanger. In some embodiments, the stator electromagnetically may be coupled to a rotor, and the stator may be disposed at least partially within the rotor.

It should be appreciated that the foregoing concepts, and additional concepts discussed below, may be arranged in any suitable combination, as the present dis closure is not limited in this respect. Further, other advantages and novel features of the present disclosure will become apparent from the following detailed description of various non-limiting embodiments when considered in conjunction with the accompanying figures.

The accompanying drawings are not intended to be drawn to scale. In the drawings, each identical or nearly identical component that is illustrated in various figures may be represented by a like numeral. For purposes of clarity, not every component may be labeled in every drawing. In the drawings:

### BRIEF DESCRIPTION OF DRAWINGS

FIG. 1 shows a cross-sectional view of a pair of back-to-back electric machines according to some embodiments;

FIG. 2 shows a perspective view of an electric machine according to some embodiments;

FIG. 3 shows a cross-sectional view of the electric machine of FIG. 2 according to some embodiments;

FIG. 4 shows an exploded view of the electric machine of FIG. 2 according to some embodiments;

FIGS. 5A-5C show various views of a rotor and stator assembly according to some embodiments;

FIG. 6A shows a schematic winding pattern for power electronics of an electric machine according to some embodiments;

FIG. 6B shows an inverter for power electronics of an electric machine according to some embodiments;

FIG. 7 shows a perspective view of a heat exchanger according to some embodiments;

FIG. 8 shows a close-up of a portion of the heat exchanger of FIG. 7 according to some embodiments;

FIG. 9 shows a front view of a portion of an electric machine according to some embodiments;

FIGS. 10A-10B show cross-sectional views of an electric machine according to some embodiments;

FIG. 11 shows a contour plot of specific power as a function of mechanical s peed and shear stress for an electric machine according to some embodiments;

FIG. 12 shows a contour plot of length-to-tip aspect ratio as a function of mechanical speed and electromagnetic loading factor for an electric machine according to some embodiments;

FIG. 13 shows a contour plot of air gap speed as a function of mechanical s peed and electromagnetic loading factor for an electric machine according to so me embodiments;

FIG. 14 shows a contour plot of the number of pole pairs as a function of mechanical speed and electromagnetic loading factor for an electric machine according to some embodiments

FIG. 15 shows a contour plot of air gap thickness as a function of mechanical speed and electromagnetic loading factor for an electric machine according to some embodiments; and

FIG. 16 shows a contour plot of stator slot current density as a function of mechanical speed and electromagnetic loading factor for an electric machine according to some embodiments.

### DESCRIPTION OF EMBODIMENTS

The Inventors have recognized that it may be desirable in certain applications to provide electric machines with high specific output powers. For example, electric machines used in jet engines and aircraft may need specific output powers greater than those typically provided in stationary applications, which may have more flexible size and weight requirements.

The Inventors have recognized that greater specific powers can theoretically be achieved by running the machines at greater speeds and minimizing power loss es while reducing the overall footprint (in both weight and volume) of the machine. However, the Inventors have also recognized that greater speed and power operation can generate increased heat and stresses within the machine, which can result in inefficiencies, losses, and potential damage if not appropriately handled. In addition, the Inventors have recognized that achieving high specific powers can be particularly challenging given the significant diversity and complexity of system parameters which contribute to specific power, such as rotor velocities, operational frequency, and stator slot current density, among many others. M any such system and operational parameters can be interdependent and non-linear, further complicating the process of achieving a particular specific power performance. Therefore, determining the appropriate combination of the many different parameters involved, as well as designing the relevant construction to achieve desired specific power outputs is a highly challenging problem.

In view of the above, the Inventors have recognized the benefits associated with an electric machine system precisely designed and operated with an appropriate combination of operating parameters to achieve high specific powers with minimal losses. The Inventors have also recognized the benefits associated with an electric machine with a thermal management system capable of retaining the electric machine at a functional thermal state, despite its performance parameters. However, instances in which different benefits are offered by the systems and methods disclosed herein are also possible.

In some embodiments, a system may include an electric machine, power electronics, and a thermal management system. The subsystems and components may be tightly and precisely integrated and optimized at the system level to achieve a high overall system power-to-mass ratio, resulting in high specific powers and minimal losses. High specific powers may be beneficial for turboelectric, hybrid-electric and full-electric propulsion in aviation and aircraft application. The systems described herein may be designed to provide one or more megawatts, but may be scaled to multi-megawatt levels dependent upon the application. How ever, other applications and overall powers may be provided using the systems disclosed herein as the disclosure is not so limited.

The various embodiments of systems disclosed herein may, in some embodiments, include an electric machine with a rotor and stator assembly. The rotor may employ permanent magnets arranged in a Halbach array. Without wishing to be bound by theory, a Halbach array of permanent magnets typically results in a stronger field on one side of the magnets (i.e., the working surface) while reducing the field on the other side of the magnetic array to be substantially less than those adjacent to the working surface, and in some embodiments substantially near zero. The magnets in a Halbach array may typically be oriented with their poles out of phase (e.g., by 90 degrees) to reroute the magnetic field to the working surface, strengthening the magnetic field at the working surface and reducing the magnetic field of the non-working surface. Rotors using magnets arranged in a Halbach array may benefit from increased power density and efficiency. In some embodiments, the Halbach array magnets may not need a back iron or steel, which may reduce the overall weight and inertia of the machine and reduce the eddy current losses associated with back irons seen in typical electric machines. This reduction in weight may increase the range of operable rotational speeds of the rotors as well as increase the achievable specific power ranges.

The thermal management system of the various embodiments disclosed herein may include a heat exchanger integrated directly into a stator assembly of an electric machine. The heat exchanger may have significant surface area configured to absorb and transport thermal energy away from the stator, which may generate significant thermal energy during operation. The heat exchanger may be thermally and mechanically coupled to the stator to maximize thermal energy transport away from the stator and provide structural support. In some embodiments, the heat exchanger may be arranged radially inwards from the stator and in the mal contact, either direct or indirect, with the stator to absorb heat from the stator during operation. In some embodiments, the heat exchanger may also be configured to couple the stator to a frame of the electric machine. In some embodiments, the heat exchanger may be configured to retain the stator stationary relative to the frame of the electric machine when a torque is applied to the stator by the rotor. As will be described in greater detail below, in some embodiment, the heat exchanger may be specifically designed to be mechanically robust to withstand torques applied to the stator during operation.

In some embodiments, the thermal management system may be configured to flow a fluid (e.g., air or other appropriate gas) through the overall system during operation to transport thermal energy away from components which may be generating said energy (e.g., conductive windings of a stator and/or power electronics). The system may include at least two fluid flow paths designed to flow through the system to absorb and subsequently transport thermal energy away. In some embodiments, a first gas stream may flow through the system towards an air gap in between the rotor and the stator to cool the assembly. Additionally, a second gas stream may flow through the heat exchanger in thermal contact with the stator to further cool the stator and overall assembly. In some embodiments, the fluid may be actively flown through the system using a pressurized source of gas such as a pump, pressurized reservoir, or other appropriate source of pressurized gas that may flow through the system during operation.

In some embodiments, the various constructions and operating parameters described herein may provide systems capable of operating with specific powers bet ween 10 kW/kg and 20 kW/kg, and in some instances, with powers of one megawatt or more. Additionally or alternatively, in some embodiments, the various systems of the present disclosure may exhibit electromagnetic loading factors between 0.25 and 0.35. Furthermore, additionally or alternatively, the various systems of the present disclosure may exhibit electromagnetic loading factors between 0.25 and 0.35 in combination with mean rotor velocities of 190 m/s and greater, relative to the stator. In some embodiments, the systems described herein may employ an electromagnetic shear stress greater than 35 kPa (5 psi) in combination with mean rotor velocities of 190 m/s or greater. Without wishing to be bound by theory, the electromagnetic loading factor may be defined as the electromagnetic shear stress of the electric machine (e.g., between the rotor and the stator) divided by the core saturation flux density-limited value, τₘₐₓ. As will be described in further detail below, the core saturation flux density-limited value may be defined as Math. 1, where B_{c} is the material saturation flux density and μ₀ is the permeability of free space.

$${τ}_{max} = \frac{{B}_{c}^{2}}{16 {μ}_{0}} \qquad [ Math . 1 ]$$

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

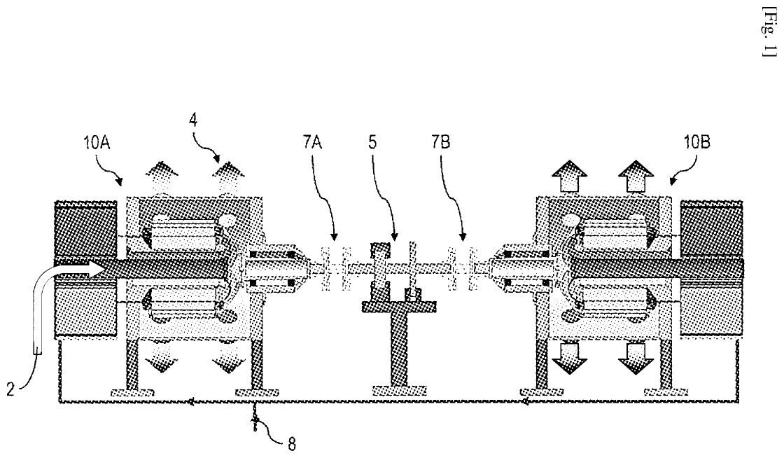

FIG. 1 shows a cross-sectional view of an exemplary pair of back-to-back electric machines 10A, 10B used for demonstration and testing purposes. One of the machines 10A may serve as a motor, outputting mechanical energy, while the other machine 10B may serve as a generator, outputting electrical energy. In some embodiments, the back-to-back electric machines may both be connected to a center shaft assembly 5, which may include a brake and torquemeter, with one or more flexible couplings 7A, 7B. In some embodiments, an external pow er supply may be connected in between the machines 10A, 10B to make up for losses inherent in the system. Each machine 10A, 10B may be cooled with a fluid (e.g., air) 2 from an external source to absorb heat generated by operation of the system and reduce heat-based losses. The fluid may flow out of more or more ports as exhaust. In some embodiments, the electric machines of FIG. 1 may be used in megawatt scale technologies. The arrangement shown in FIG. 1 may be used to test various operational parameters.

It should be appreciated that the electric machines of the present disclosure m ay be arranged in any suitable manner, including the back-to-back arrangement outlined in FIG. 1. In other embodiments, a single electric machine may be employed (e.g., when used in an aircraft) as either a motor and/or generator. It should be appreciated that the electric machines described herein are not limited by their arrangement or number of machines used in a particular application.

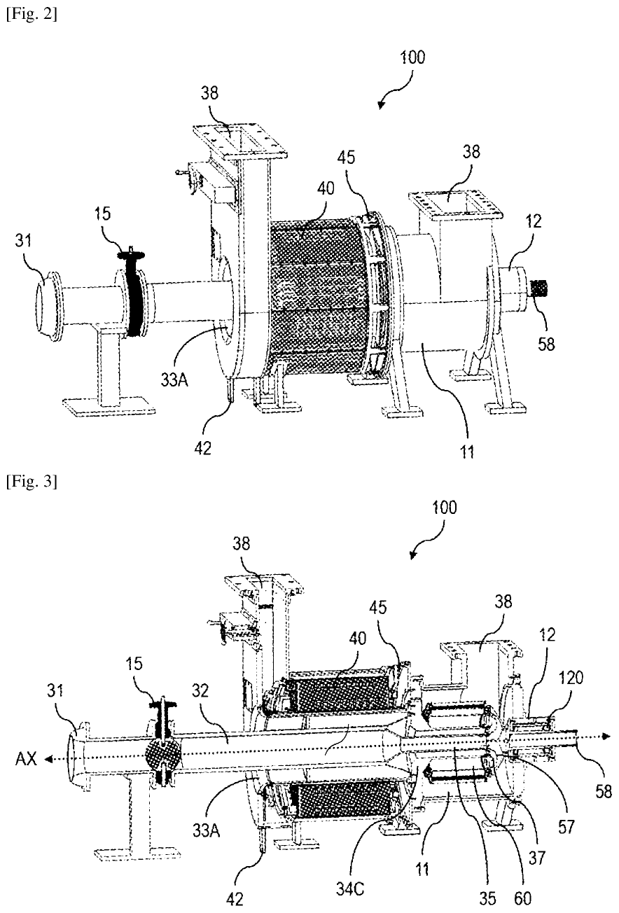

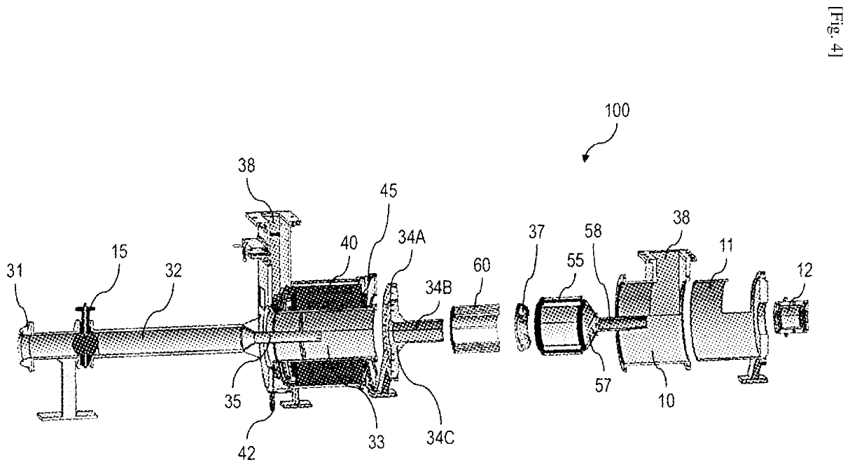

FIGS. 2-4 show various views of a system 100 employing a single electric machine, which may serve as a generator or a motor depending on the application. The machine may be used individually or in combination with other machines. FIG. 3 shows a cross-sectional view of the system 100 and FIG. 4 shows an exploded view of the system 100, with various components separated in space.

As shown in FIGS. 2-4, in some embodiments, mechanical energy may be transported into (e.g., for a generator) and/or out from (e.g., for a motor) the system 100 through a driveshaft 58 positioned along a longitudinal axis AX. The driveshaft 58 may be connected to the machine with bearings 120 such that the driveshaft rotates about the axis AX inside a bearing housing 12 during operation. The bearing housing 12 may be coupled to and held stationary relative to a stationary frame 11, which itself may be held stationary relative to an underlying supporting surface during operation. The frame 11 may be formed in multiple segments which may be connected to one another, directly or indirectly, to stabilize and maintain the machine stationary relative to a surface. However, integrally formed frames may also be used.

In some embodiments, the driveshaft 58 may be rotationally coupled (e.g., welded, bolted, threaded onto, and/or any other appropriate type of connection) to a flange 57 of a rotor drum 55. Accordingly, the driveshaft may be rotationally coupled to the rotor drum which may rotate about a stator. The flange 57, which may be in the form of a flow-guide, end bell, or other appropriate construction may serve to redirect fluid flow within the system for thermal management as will be described in greater detail below. The flange 57 may include a con toured surface to turn and diffuse fluid flow while minimizing pressure losses in the cooling flow.

In some embodiments, the rotor drum 55 may coaxially overlap a heat exchanger 60 as part of the thermal management of the system, with the heat exchanger 60 positioned radially inwards relative to, and disposed at least partially with in, the rotor. The heat exchanger 60 may be stationary relative to the frame of the system. Accordingly, the rotor may rotate about a shared axis AX of the heat exchanger 60 and the stator. In some embodiments, the heat exchanger may be coupled to a stationary flow flange 37 for redirecting fluid flow within the system. As shown in FIG. 3, the flange 37 (which may be in the form of a flow-guide or end bell) may be positioned radially inwards of the flange 57 relative to the axis AX. The flange 37 may be connected to a flow separator tube 35, which may extend axially away from a central portion of the flange 37, as shown in FIGS. 3-4. Accordingly, fluid flowing along the axis AX may flow from the flow separator tube 35 into the flange 37, and subsequently toward the heat exchanger 60 due to the curvature of the flange. In some embodiments, the flange 37 may turn the flow of fluid 180 degrees, although other degrees of flow redirection are also contemplated. The flange 37 may include a contoured surface to turn and diffuse fluid flow while minimizing pressure losses in the cooling flow.

In some embodiments, a spindle 34B may be arranged radially in between the flow separator tube 35 and the heat exchanger 60 relative to the axis AX. The spindle 34B may include a casing plate 34A at a first end and may be coupled to the flange 37 at the second end. Accordingly, the arrangement of components from the axis AX outwards includes the flow separator tube 35, positional coaxially with the spindle 34B, which may be coupled to the heat exchanger 60, which in turn may be coupled to the stator to maintain the stator stationary to the frame. It should be appreciated that the rotor may be arranged at least partially coaxial with the stator with one or more components of the frame 11.

In some embodiments, the spindle may be a stationary shaft configured to sup port the stator of the electric machine. The spindle 34B may be in the form of a cantilevered structure and may be excited by the electromagnetic forces between the rotor and stator. The Inventors have recognized that since the spindle also supports the torque of the stator, installing a damper between the spindle and the casing plate may be infeasible. Therefore, to dampen the frequency of the mode which may excite the spindle, a thick conical structure 34C (see FIGS. 3-4) may be employed to stiffen the connection between the spindle 34B and frame 11. The conical structure 34C may strengthen the connection between the spindle and the frame. In some embodiments, the conical structure may be angled relative to the axis AX. The conical structure may be angled at any suitable angle relative to axis AX, including greater than or equal to 40°, 50°, 60°, 70°, and/or any other suitable angle. The conical structure may also be angled at less than or equal to 70°, 60°, 50°, 40°, and/or any other suitable angle relative to axis AX. Combinations of the foregoing, including the conical structure angled at an angle between 50 and 60 degrees relative to axis AX, are also contemplated.

It should be appreciated that the conical structure may have any suitable geo metric properties as the present disclosure is not limited by the geometry of the conical structure 34C. In some embodiments, a thickness (along axis AX) of the conical structure may be approximately between 40 mm to 76 mm, although other geometries are also contemplated. In some embodiments, the spindle, which may or may not include the above noted conical structure. For example, the spindle may have resonant frequencies that are outside the operating frequency ranges of the system during nominal operation including startup and shutdown. Of course, alternative methods of dampening the spindle may also be employed, as the present disclosure is not so limited.

In some embodiments, as shown in FIG. 3, the flow separator tube 35 may extend beyond the casing plate 34A and toward a cooling tube 32, which may include an inlet 31 at one end. As will be described in greater detail below, the cooling tube 32 may be in fluid communication with an air gap in between the rotor and the stator of the system. The inlet 31 may be in fluid communication with an external fluid source for cooling the system. For example, the inlet may be in fluid communication with bleed air from the low-pressure or high-pressure compressor of an acroengine. Other embodiments of an external fluid source are also contemplated. In some embodiments, the cooling tube 32 may include an inlet flow valve 15 which may control the flow of fluid from the inlet 31 to the cooling tube 32.

In some embodiments, a support tube 33 may be disposed radially around the flow separator tube 35, as shown in FIG. 4, may retain a plurality of power electronics 40 stationary relative to the frame 11 while also providing a fluid flow path for the system, as will be described in greater detail below. In some embodiments, the power electronics 40 may be arranged in a toroidal layout about axis AX, although other arrangements are also contemplated. In some embodiments, the power electronics 40 may be arranged in a radial spaced apart configuration about axis AX, although other arrangements are also contemplated. The support tube 33 may have a support tube inlet 33A, as shown in FIG. 3. In some embodiments, the frame 11 may include one or more vents 45 to allow fluid flow towards and/or away from the power electronics 40.

Accordingly, a first stream of fluid may flow from a fluid source into the inlet 31, through the valve 15, through the cooling tube 32, into the flow separator tube 35, into the flange 57, which may serve to redirect the fluid flow (e.g., redirect flow to be 180° from the original flow direction), and subsequently through an air gap between the rotor and stator. This fluid stream may serve to transport thermal energy away from the rotor and stator assembly, which generates heat during operation. In some embodiments, this fluid stream may also flow through one or more end turns of the stator to further cool the stator windings, as will be described in greater detail below.

In some embodiments and as will be described in greater detail below, a second stream of fluid may flow into the system through a support tube inlet 33A, as shown in FIG. 3, and into an interstitial space between the spindle 34B and the flow separator tube 35, and subsequently flow into flange 37, which may redirect the flow of fluid through channels of a heat exchanger 60. The fluid in the second stream may therefore absorb heat from the heat exchanger, which may be in thermal communication with the stator (which, as noted earlier, may generate heat during operation), and subsequently transport thermal energy away from the heat exchanger to cool the stator. The flanges 37 and 57 may include one or more curved surfaces to turn the direction of flow 180° from the original flow direction, as will be described in greater detail below.

In some embodiments, the system may include one or more ports 38 to allow exhaust fluid to flow out after passing through the system (e.g., fluid passing through the heat exchanger and/or air gap may exit through the ports). The ports may be formed in the stationary frame 11 at any suitable location. It should be appreciated that in some embodiments, fluid may be pumped out of the system with an external pump. In these embodiments, the external pump may be fluidically connected to the ports. In other embodiments, fluid may be pumped in to the system with an external pump connected to the inlet 31. Of course, other arrangements of fluid introduced into and/or transported out of the system may also be employed.

In some embodiments, the electric machine may be operated with a plurality of power electronics 40 positioned proximal to the rotor and stator, as shown in FIGS. 2-4. Compared to the conventional arrangement of electronics positioned remotely relative to the machine, losses associated with electrical signal transfer over long distances may be reduced. In addition, the power electronics may be cooled with the thermal management system of the electric machine. These features may reduce the overall weight and volume footprint of the system, enabling higher performance regimes while also increasing the achieving specific pow er output ranges. Furthermore, in some embodiments, the proximity of the power electronics to the electric machine may result in faster communication, and subsequently, more efficient operation.

In some embodiments, the system may include one or more connectors 42 in electrical communication with the power electronics 40. The connectors 42 may serve to transport electrical energy out of and/or into the system. In some embodiments, the connectors 42 may in electrical communication with an external electric source 8 (see FIG. 1).

In some embodiments, the power electronics 40 may include a plurality of inverters configured to control the operation of the electric machine. The inverters may include any suitable combination of electronic components, including one or more processors and/or memory components which may be useful for operation. In some embodiments, the inverters (which may be in electrical communication with an external power supply) may control the frequency of the power sup plied to the electric machine to control its rotational speed. In some embodiments, the inverters may convert signals from the power supply (e.g., from AC to DC, or from AC to DC) to the power electronics 40 for consumption.

In some embodiments, the power electronics 40 may be electrically coupled with the windings of the stator. Accordingly, the inverters may be radially arranged around a support tube 33 coaxial with the cooling tube 32 to connect the various poles of the stator to the power electronics. In some embodiments, each of the three-phase inverter sets, consisting of three separate single-phase full-bridge inverters, of the power electronics may correspond to a pole pair, although other arrangements are also contemplated. It should be appreciated that the proximity of the power electronics to the electric machine may serve to reduce the overall footprint of the system, as well as reduce the losses associated with electrical transport over long distances. The position of the power electronics proximal to the electric machine may therefore minimize the lead length of any electrical connections between the machine and the electronics.

In some embodiments, the power electronics 40 may be arranged in a toroidal fashion about axis AX such that the separate power electronics associated with the separately controlled pole pairs of the system may be disposed radially aro und a perimeter, and in some instances, spaced axially from, the stator 51. The power electronics 40 may also be closely coupled to the electric machine, which may be characterized by a ratio 2 L/Lₜₒₜ, where L is the lead length (measured between the power electronics and the electric machine and in some instances the stator of the electric machine) and where Lₜₒₜ is the total single-phase winding length. The multiplier of the integer 2 may serve to accommodate the length associated with two wires running back and forth between the power electronics and the electric machine. In an exemplary embodiment the lead length L may be 200 mm and Lₜₒₜ may be 5357 mm, accounting for the total length of the single-phase winding with ten turns in series, resulting in a 2 L/Lₜₒₜ of approximately 7.5%. In some embodiments, a “close-coupled” system may be characterized by the ratio 2 L/Lₜₒₜ being less than or equal to 15%. It should be appreciated that the ratio 2 L/Lₜₒₜ may be less than, equal to, and/or greater than 15%, as the present disclosure is not limited by the ratio of lead length to single-phase winding length.

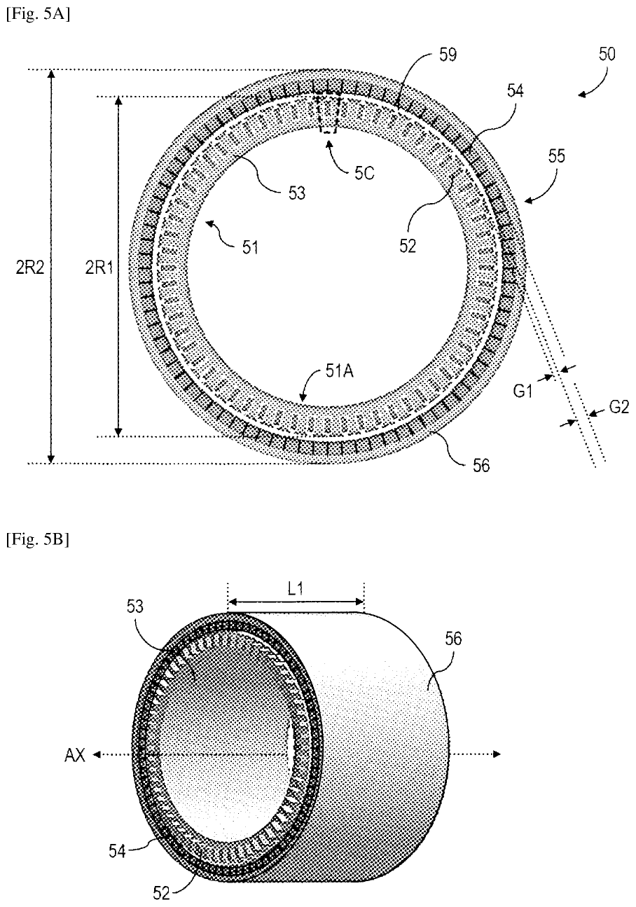

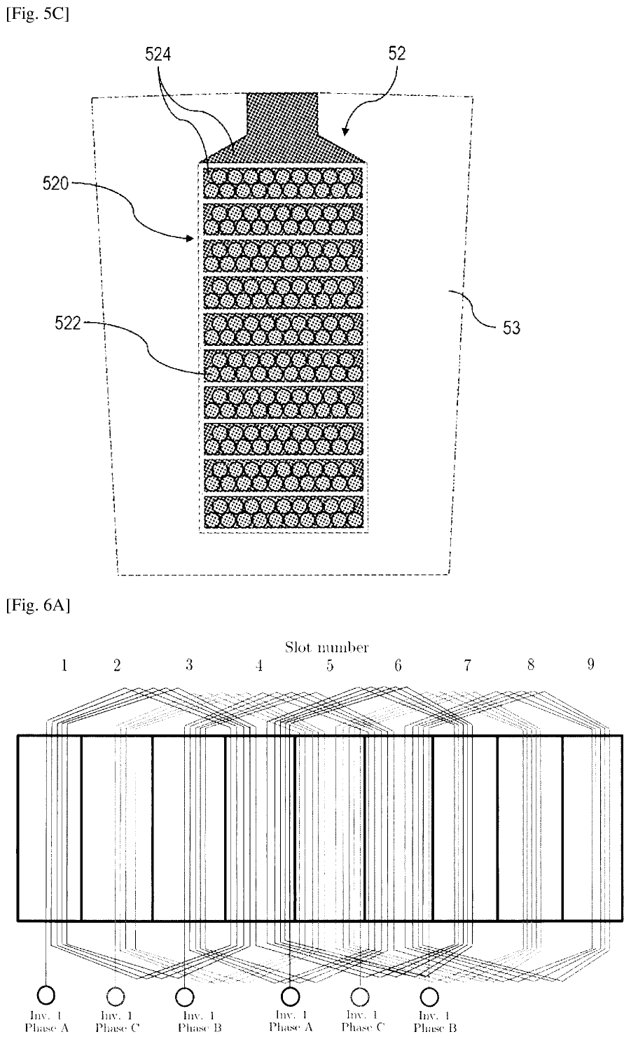

FIGS. 5A-5B show an embodiment of a rotor and stator assembly 50 used in an electric machine that may be included in the various systems and electric machines disclosed herein. The rotor 55 and stator 51 may be in electromagnetic communication, such that rotation of the rotor around the stator may generate an output in the form of electrical and/or mechanical energy. Accordingly, the stator may be held stationary relative to the frame of the system. The rotor and stator assembly 50 may be housed within a rotor drum that is connected to the rotor (see drum 55 in FIGS. 2-4).

The rotor 55 and stator 51 may be coaxially arranged with one another with at least a portion of the rotor and stator overlapping one another along an axis AX. The stator 51 may be positioned radially inwards of the rotor 55 relative to the axis AX. In some embodiments, the rotor 55 and stator 51 may be radially spaced apart by an air gap 59 with an air gap thickness G1, as shown in FIG. 5A to allow the rotor to rotate about the axis AX while the stator remains rotationally stationary. The air gap thickness may be measured radially from the axis AX to between the outer edges of the teeth 52 of the stator and the magnets 54 of the rotor, or other appropriate portions of the stator and rotor that define the radial gap between the stator and rotor.

The air gap thickness G1 may be any suitable thickness to account for the sizing and alignment tolerances of the rotor and the stator, as well as any potential vibrations of the system, while remaining small enough to avoid reducing the efficiency of the motor via losses. In some embodiments, the air gap thickness G1 may be greater than or equal to 1 mm, 1.5 mm, 2 mm, 2.5 mm, 3 mm, 3.5 mm, 4 mm, 4.5 mm, 5 mm, and/or any other suitable thickness. The air gap thickness G1 may also be less than or equal to 5 mm, 4.5 mm, 4 mm, 3.5 mm, 3 mm, 2.5 mm, 2 mm, 1.5 mm, 1 mm, and/or any other suitable thickness. Combinations of the foregoing ranges are also contemplated, including, but not limited to, an air gap thickness G1 between or equal to 1 mm and 5 mm, 2 mm and 4 mm, 2.5 mm and 3.5 mm, 1 mm and 4 mm, and/or any other suit able range of thicknesses. In some embodiments, the air gap thickness G1 may be between 1 mm and 4 mm. It should be appreciated that air gap thicknesses smaller than or greater than the foregoing are also contemplated, as the present disclosure is not limited by the air gap thickness G1.

The air gap 59 may also be characterized by an air gap radius R1, as shown in FIG. 5A. The air gap radius R1, which may also account for the size of the stator positioned radially inwards of the air gap, may be any feasible value compatible with the manufacturing and operation of the system. As will be described below, in some embodiments, air gap radius R1 may help determine the parameter space used to establish high specific power operation of the system. The air gap radius R1 may be greater than or equal to 100 mm, 110 mm, 120 mm, 130 mm, 140 mm, 150 mm, 160 mm, 170 mm, 180 mm, and/or any other suitable radius. The air gap radius R1 may also be less than or equal to 180 mm, 170 mm, 160 mm, 150 mm, 140 mm, 130 mm, 120 mm, 110 mm, 100 mm, and/or any other suitable radius. Combinations of the foregoing ranges, including, but not limited to, an air gap radius R1 between or equal to 100 and 180 mm are also contemplated. In some embodiments, the air gap radius R1 may be between or equal to 120 mm and 140 mm, and in some embodiments more preferably about 130 mm. Of course, radii less than or greater than the fore going may also be employed, as the present disclosure is not limited by the air gap radius.

In some embodiments, the air gap 59 may be characterized with a nondimensional air gap radius defined by the ratio of the air gap thickness G1 and the air gap radius R1. The nondimensional air gap radius may be any suitable value, including, but not limited to, greater than or equal to 0.005, 0.01, 0.02, 0.03, 0.04, 0.05, and/or any other suitable value. The nondimensional air gap radius may also be less than or equal to 0.05, 0.04, 0.03, 0.02, 0.01, 0.005, and/or any other suitable value. Combinations of the foregoing, including nondimensional air gap radii between 0.01 and 0.03, are also contemplated, as the present disclosure is not limited by the value of the nondimensional air gap radius.

The rotor and stator assembly 50 may be characterized by a rotor radius R2, as shown in FIG. 5A. The rotor radius R2 may be any feasible value compatible with the manufacturing and operation of the system. The rotor radius R2 may be greater than or equal to 100 mm, 120 mm, 130 mm, 140 mm, 150 mm, 160 mm, 170 mm, 180 mm, 200 mm, 210 mm, and/or any other suitable radius. The rotor radius R2 may also be less than or equal to 210 mm, 200 mm, 180 mm, 170 mm, 160 mm, 150 mm, 140 mm, 130 mm, 120 mm, 100 mm, and/or any other suitable radius. Combinations of the foregoing ranges, including, but not limited to, a rotor radius R2 between or equal to 100 mm and 210 mm are also contemplated. In some embodiments, the rotor radius R2 may be between 100 and 200 mm, more preferably about 150 mm. Of course, radii less than or greater than the foregoing may also be employed, as the present disclosure is not limited by the rotor radius.

In some embodiments, the rotor 55 may be formed of a plurality of permanent magnets 54 arranged in a Halbach array. The magnets may be disposed radially inward from and mechanically coupled to a retaining sleeve 56, as shown in FIG. 5A. As described previously, the Halbach arrangement may help minimize the presence of a magnetic field on the non-working surface of the rotor oriented in a radially outwards direction, such that in some embodiments, the rotor may not include a back iron or steel layer. In this way, eddy losses, weight, and inertia of the machine may be reduced, allowing for greater operational speeds and higher specific powers. Of course, embodiments of rotors with back irons are also contemplated.

The magnets may be formed of any suitable permanent magnet material, including, but not limited to, samarium-cobalt (e.g., Recoma 35E from Arnold Magn etic Technologies), neodymium-iron-boron, combinations thereof, and/or any other suitable permanent magnet material. The magnets may be formed of any suitable material that is stable under the expected operating temperatures and conditions of the system including, for example, operating temperatures between or equal to 150° C. and 250° C., 150° C. and 200° C., 100° C. and 300° C., 100° C. and 200° C., combinations thereof, and/or any other suitable operating temperature ranges.

In some embodiments, the retaining sleeve, which may be a load-bearing component, may be formed of lightweight material to reduce the overall mass of the system. For example, the retaining sleeve may be formed of a titanium alloy, such as Ti-6Al-4V, although other lightweight materials are also contemplated, including, but not limited to aluminum alloys (including, but not limited to, 707 5-T6). The magnets may be adhered to the retaining sleeve using any suitable high temperature adhesive including, but not limited to, urethane methacrylate es ter acrylic adhesives (e.g., Loctite AA 334). In some embodiments, a filler adhesive may be used to fill in gaps between the permanent magnets. The filler adhesive may include, but is not limited to, epoxy resins (e.g., Armstrong A-661), 3M DP420, Loctite AA334, combinations thereof, and/or any other suitable filler adhesives stable under the operating temperatures listed above. It should be appreciated that the filler adhesive may be non-conductive to limit eddy current circulation. Of course, any suitable adhesives, combinations of adhesives, and/or other types of attachments may be employed to assemble the systems described herein, as the present disclosure is not so limited.

In some embodiments, the magnets 54 of the rotor may be characterized by a magnet thickness G2 measured radially relative to axis AX, as shown in FIG. 5A. The magnet thickness G2 may be any suitable thickness compatible with the manufacturing and operation of the systems described herein. The magnet thickness G2 may be greater than or equal to 5 mm, 7 mm, 8 mm, 9 mm, 10 m m, 11 mm, 12 mm, 14 mm, 15 mm, 20 mm, and/or any other suitable thickness. The magnet thickness G2 may also be less than or equal to 20 mm, 15 m m, 14 mm, 12 mm, 11 mm, 10 mm, 9 mm, 8 mm, 7 mm, 5 mm, and/or any other suitable thickness. Combinations of the foregoing ranges, including, but not limited to, a magnet thickness G2 between or equal to 5 mm and 20 mm are also contemplated. In some embodiments, the magnet thickness G2 may be bet ween 5 and 20 mm, more preferably about 10 mm. Of course, magnet thicknesses less than or greater than the foregoing may also be employed, as the present disclosure is not limited by the magnet thickness of the rotor.

In some embodiments, the stator 51 may include a plurality of conductors 52 arranged in a tooth-and-slot core 53. The conductors are represented as blocks in FIGS. 5A-5B for simplicity, but may be wire-shaped windings in practice. In some embodiments, the windings may be formed from copper wires operable up to 100° C., 120° C., 150° C., 160° C., 180° C., 200° C., and/or any other suitable operational temperatures. In some embodiments, the windings may preferably be operable up to 180° C. It should be appreciated any suitable winding material insulation may be employed, as the present disclosure is not so limited.

The tooth-and-slot core 53 may be formed of thin laminations along the axis AX (see FIG. 5B), stacked, welded, and/or bonded together, which may reduce losses associated with eddy currents. In some embodiments, each lamination may be 4 mil (0.1016 mm) measured along axis AX, although other thicknesses less than or greater than 4 mil, including about 6 mil are also contemplated.

In some embodiments, the core 53 may be formed of an Iron Cobalt Vanadium (FeCoV) alloy. For example, the core may be formed of Hiperco 50 (Cartech) or Vacoflux 48 (Vacuumschmelze). Of course, other high saturation magnetic flux density materials may also be employed. In some embodiments, the stator may include 2000 lamination layers, although embodiments having less than or greater than 2000 lamination layers are also contemplated. It should be appreciated that the number of lamination layers may be determined by the lamination layer thickness as well as the total length of the stator (see length L1 in FIG. 5B). In some embodiments, the lamination layers of the stator core may be plated with a core plating material for insulation purposes. The core plating material may be an organic material (e.g., a C-5 lacquer), which may exhibit a lower loss of magnetic performance compared to conventional oxide core plating materials. Neighboring lamination layers may be adhered to one another using any suitable heat and pressure sensitive adhesives to reduce eddy current losses.

The Inventors have recognized that the conventional technique of annealing the laminations after stamping or cutting to improve magnetic performance may undesirably induce a 0.2% anisotropic growth in the stator, which may make it difficult to maintain tolerance of the stator post-anneal. Such tolerances are useful when integrating the stator on to the heat exchanger. Accordingly, in some embodiments, the stator laminations of the present disclosure may be annealed prior to cutting. The laminations may subsequently be cut with a photochemical etchant, which may reduce the stresses imposed on the cut edges. Such edge stresses may impact magnetic performance via magnetostriction. Of course, alternate modes of forming laminations are also contemplated.

As shown in FIGS. 5A-5B, the stator 51 may be positioned coaxial with the rotor 55 along axis AX, as well as radially inwards of the rotor 55. In some embodiments, the overlapping portion of the rotor and stator assembly 50 may extend a length L1 along axis AX, as shown in FIG. 5B. The length L1 may be any length compatible with the manufacturing and operation techniques described herein. As will be described below, in some embodiments, the length L1 may help determine the parameter space used to establish high specific power operation of the s system. The length L1 may be at least 180 mm, 185 mm, 190 mm, 195 mm, 200 mm, 205 mm, 210 mm, 215 mm, 220 mm, and/or any other suitable length. The length L1 may also be less than or equal to 220 mm, 215 mm, 210 mm, 205 mm, 200 mm, 195 mm, 190 mm, 185 mm, 180 mm, and/or any other suitable length. Combinations of the foregoing ranges, including, but not limited to, a length L1 between or equal to 180 mm and 220 mm are also contemplated. In some embodiments, the length L1 of the rotor and stator assembly 50 may be about 200 mm. Of course, lengths less than or greater than the foregoing may also be employed, as the present disclosure is not limited by the rotor and stator assembly length.

FIG. 5C shows a close-up view of a portion of the stator FIG. 5A showing a series of conductors 52 in the tooth-and-slot core 53. In some embodiments, the conductor layout may include ten turns, each turn including a type 8 rectangular Litz bundle consisting of two rows of US AWG 24 Litz strands 522. In so me embodiments, each turn may include nineteen strands 522, as shown in FIG. 5C, although other configurations are also contemplated. The turns may be separated by slot liners 520, and the interstitial space between strands 522 and turns may be filled with a potting material 524. In some embodiments, the slot liners may be formed of an insulation material thermally stable up to 200° C., including, but not limited to Nomex 410 (DuPont). In some embodiments, the pot ting material may include thermally conductive silicones such as CoolTherm SC-324 (Lord Corporation). In some embodiments, each strand may be coated with an insulation layer thermally stable at the expected operating temperatures as noted above. For example, the strand insulation coating layer may include a poly ester layer coated over a polyamide-imide layer which may be applied to the copper wire of the conductive windings. In some embodiments, the insulation coating layer may be 0.95 mm of MW-35C. In other embodiments, the insulation coating layer may be Kapton-MT. It should be appreciated that other suitable materials used for the windings, insulation materials, potting materials, and slot liners may be employed as the present disclosure is not so limited.

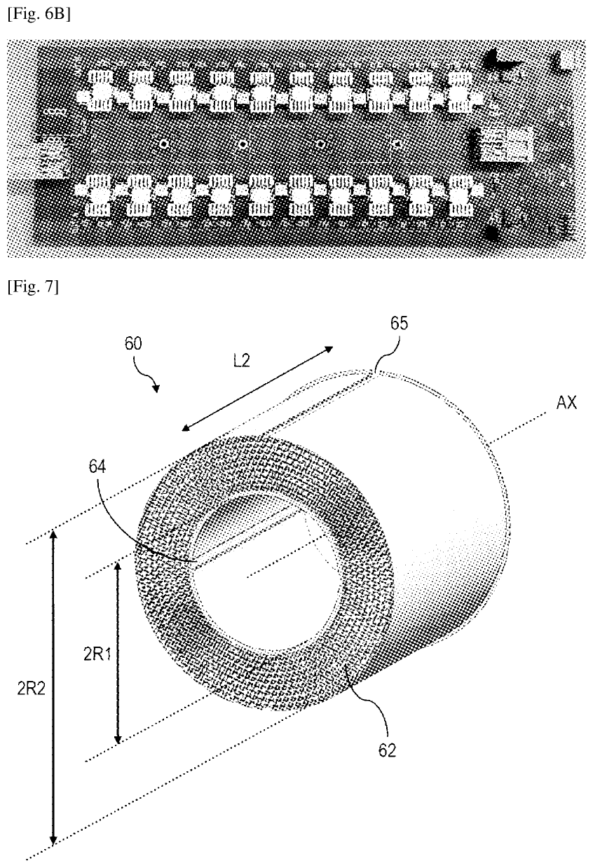

FIG. 6A shows an exemplary winding pattern connecting the rotor-and-stator assembly of FIGS. 5A-5C to power electronics (e.g., power electronics 40 in FIG. 3). The winding pattern shown in FIG. 6A represents just one pole pair. Each phase (i.e., A, B, and C) may be connected to its own full bridge inverter. Accordingly, there may be three inverter circuits per pole pair. Each inverter may be connected to ten turns in series, five turns around three slots of the stator, and five turns around the next three, as shown in the top-down view of FIG. 6A. Of course, it should be appreciated that any number of pole pairs, inverters, turns per inverter, and/or turns around the slots of the stator may be employed, as the present disclosure is not limited by the configuration of the winding pattern.

In some embodiments, single-phase windings may be employed in the systems described herein. Each set of three separate (e.g., independent) single-phase windings may span a pole pair of the machine. In embodiments where the system employs ten pole pairs, there may be ten sets of the three, separate single-phase windings. It should be appreciated that alternative arrangements of the three phase windings, including wye or delta configurations, may also be employed. In embodiments where non-independent winding arrangements are employed, the power electronics may be of a different inverter topology, including, but not limited to, a two-level three-phase bridge inverter (known as a three-phase inverter), or a three-phase multilevel inverter (e.g. active neutral point clamped multilevel inverter, or flying capacitor multilevel inverter, or a t-type multilevel invert er, among others). Accordingly, the output of each phase leg of these aforementioned three-phase 2-level or multilevel inverters may be connected to each phase of the wye or delta connected windings. It should be appreciated that the aforementioned inverter topologies and winding arrangements are exemplary and no n-exhaustive. In some embodiments, the windings may be concentrated or distributed (e.g., either full-pitched or short-pitched). It should be appreciated that such distributions may not affect the number of inverter drives.

FIG. 6B shows an exemplary single phase, full bridge inverter for an electric machine (e.g., a megawatt class turbo-integrated electric machine). In some embodiments, the windings of the rotor-and-stator assembly may be connected to a set of 30 full bridge inverters of FIG. 6B. The three-phase windings may be in dependent (separate) from each other (as in the case of the single-phase full-bridge motor drive described previously), or connected in wye or delta configurations. In some embodiments, one three-phase inverter set may drive a three-phase winding whose coils span a pole, or drive a three-phase winding whose series connected coils span a pole pair (two poles), or may drive a three-phase winding whose series connected coils span an integer multiple of poles or pole pairs. Therefore, the number of three-phase inverter sets may be equal to the number of poles, the number of pole pairs, or an integer fraction of the number of po les or pole pairs of the system. Such inverters may be designed for specific weight and area merits, simplicity of construction, and reliability compared to alter natives (e.g., a 2-level three-phase bridge inverter or 3-level active neutral-point clamped inverter). In some embodiments, an overall system including 30 invert ers may achieve an estimated standalone specific power of 37.8 kW/kg and 98.3% efficiency. It should be appreciated that any number of inverters greater than or less than 30 inverters may be employed, as the present disclosure is not limited by the number of inverters.

FIG. 7 shows a heat exchanger 60 according to some embodiments. The heat exchanger may be radially arranged about an axis AX, similar to the axis shown in FIGS. 2-4. The heat exchanger 60 may be mechanically and thermally coupled to the stator of the electric machine to facilitate thermal transport from the stator to the heat exchanger 60 and reduce performance losses of the stator as sociated with elevated temperatures. In some embodiments, the heat exchanger 60 may include one or more through channels 62 along the axis AX. The channels 62 may increase the surface area of the heat exchanger 60 to enhance the thermal conductivity of the heat exchanger. For example, a fluid flowing through the plurality of through channels of the heat exchanger may absorb a greater a mount of heat compared to a solid body. In addition, the empty space of the through channels may reduce the weight of the system and further enhance the specific power performance of the system.

As described previously in relation to FIGS. 2-4, the heat exchanger 60 may be arranged radially inwards of the stator. Based on this arrangement, the heat exchanger may be designed to both efficiently transport heat away from the stat or as well as be sufficiently structurally stable to withstand torques within the s system. For example, in embodiments where the heat exchanger is mechanically coupled to the stator to hold the stator stationary relative to an associated frame, the heat exchanger may experience at least some, or potentially all, of the tor que applied to the stator by the rotor. Accordingly, the heat exchanger may be designed to provide mechanical strength to retain the stator substantially stationary relative to the frame.

Thus, the heat exchanger may serve two functions, including providing sufficient thermal transport away from the stator as well as providing structural support to the stator. It should be appreciated that the design of the heat exchanger channels may provide a balance between feasible thermal and structural performance, performing each function at a sufficient level. To address these functions, a variety of different channel geometries were explored, including fins arranged radially about the thermal exchanger's central axis, axial channels with a diamond-like cross-section, as well as a three-dimensional lattice extending along the central axis. The Inventors have recognized that the fin arrangement may not pro vide sufficient support to withstand the significant torques applied to the heat exchanger. In addition, the fin arrangement may not withstand compressive forces that may be applied to the heat exchanger during assembly (e.g., compression fit of the heat exchanger radially inside the stator). The Inventors have also recognized that a complex three-dimensional lattice may exhibit poor thermal trans port performance at a Reynold's number of 8,000 due to its complex geometry. The diamond shaped lattice, however, was found to provide sufficient thermal and mechanical performance. Accordingly, the channels 62 of the heat exchanger may be formed in a diamond-lattice arrangement, as shown in FIG. 7, to achieve a balance of structural stability and thermal performance. In some embodiments, the channels 62 extend parallel to the axis AX, although non-parallel channels are also contemplated.

In some embodiments, the heat exchanger 60 may be formed using an additive manufacturing technique, such as 3D printing, though other appropriate manufacturing techniques may also be used. The heat exchanger may be formed of any suitable lightweight, high thermal conductivity, and appropriate yield strength material compatible with the additive manufacturing technique, including, but not limited to A205 aluminum, steel, titanium, combinations thereof, and/or any other suitable thermally and mechanically compatible material. Of course, other material compositions for the heat exchanger are also contemplated as the present disclosure is not so limited.

In some embodiments, the heat exchanger may have an inner radius R3 and outer radius R4. The inner radius may be sized to accommodate the spindle (see spindle 34B in FIG. 4) and/or any other suitable structure on which the heat exchanger may be installed. The outer radius may be sized to allow the heat ex changer to be installed radially inwards to the stator relative to the axis AX. In some embodiments, the inner radius R3 may be greater than or equal to 20 m m, 40 mm, 45 mm, 50 mm, 60 mm, 70 mm, 80 mm, 100 mm, 120 mm, and/or any other suitable radius. The inner radius R3 may also be less than or equal to 120 mm, 100 mm, 80 mm, 70 mm, 60 mm, 50 mm, 40 mm, 20 mm, an d/or any other suitable radius. Combinations of the foregoing ranges are also contemplated, including, but not limited to, an inner radius R3 between or equal to 20 mm and 120 mm. In some embodiments, the inner radius R3 may be bet ween 40 mm and 80 mm, more preferably about 60 mm. Of course, inner radii less than or greater than the foregoing may also be employed, as the present disclosure is not limited by the inner radius size.

In some embodiments, the heat exchanger 60 may have a length L2 along axis AX. Length L2 may correspond to a similar length of the stator and/or rotor along axis AX, or may be greater than or less than a length of the stator and/or rotor. In some embodiments, length L2 may be greater than or equal to 120 mm, 150 mm, 180 mm, 190 mm, 200 mm, 210 mm, 220 mm, 250 mm, and/or any other suitable length. Length L2 may also be less than or equal to 250 mm, 220 mm, 210 mm, 200 mm, 190 mm, 180 mm, 150 mm, 120 mm, and/or any other suitable length. Combinations of the foregoing ranges are also contemplated, including a length L2 between or equal 120 and 250 mm. In some embodiments, the length L2 may be between 180 mm and 220 mm, more prefer ably about 200 mm. Of course, lengths less than or greater than the foregoing may also be employed, as the present disclosure is not limited by the length of the heat exchanger.

The outer radius R4 may be determined by the inner radius of the stator. In some embodiments, the outer radius R4 may be greater than or equal to 80 m m, 90 mm, 100 mm, 110 mm, 120 mm, 130 mm, and/or any other suitable radius. The outer radius R4 may also be less than or equal to 130 mm, 120 mm, 110 mm, 100 mm, 90 mm, 80 mm, and/or any other suitable radius. Combinations of the foregoing ranges are also contemplated, including, but not limited to, an outer radius R4 between, or equal to 80 mm and 120 mm. In some embodiments, the outer radius R4 may be between 90 mm and 130 mm, more preferably about 105 mm. Of course, outer radii less than or greater than the foregoing may also be employed, as the present disclosure is not limited by the outer radius size.

In addition, in some embodiments, the stator may experience thermal expansion due to localized heating of the windings. Accordingly, the interface between the heat exchanger and the stator may be designed to accommodate geometric variations of the stator due to thermal expansion, with minimal changes to the thermal transport between the two components. Furthermore, as discussed previously, the heat exchanger may serve a function of stabilizing the stator relative to the frame, against torques applied to the stator by the rotor. Accordingly, the interface between the heat exchanger and the stator may facilitate the retention of the stator in a fixed orientation relative to the frame under stress during operation. Thus, in some embodiments, the heat exchanger 60 may include one or m ore outer keyways 65 formed in its outer rim to facilitate an interference fit with the stator. The keyways 65 may facilitate alignment of the heat exchanger re lative to the stator, while also transferring structural support to the stator to maintain the stator stationary relative to the frame. Although two outer keyways 65 are shown in FIG. 7, any number of keyways arranged radially around the outer rim may be employed. In some embodiments, the heat exchanger 60 may include one or more inner keyways 64 formed in its inner rim to facilitate an interference fit with a portion of the stationary system (e.g., spindle). Although two inner keyways 64 are shown in FIG. 7, any number of keyways arranged radially around the inner rim may be employed.

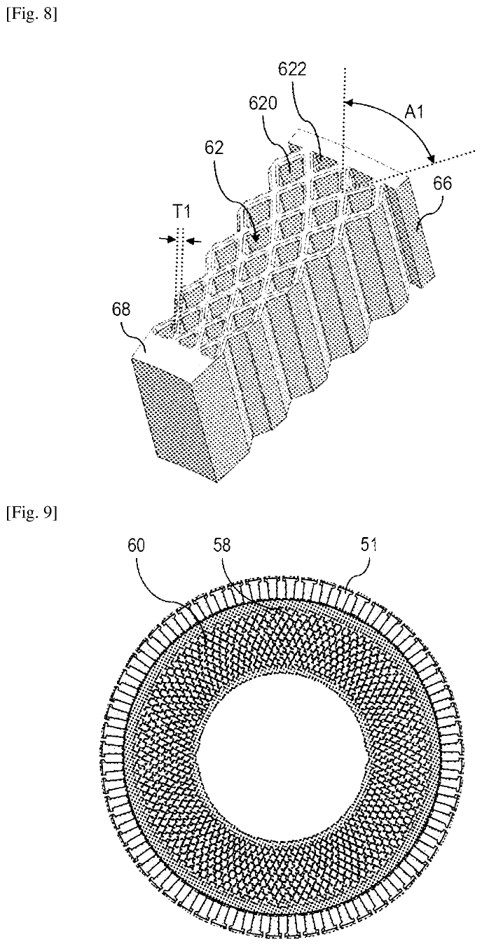

FIG. 8 shows a portion of the heat exchanger 60 from FIG. 7 depicting through channels 62 extending along the heat exchanger body. The channels 62 may be formed in between an outer rim 66 and an inner rim 68 and may be diamond-shaped in cross-section. The channels 62 may include a channel 620 having a diamond-shape in cross section and a channel 622 having a triangular-shape in cross section. The channel 622 is positioned outermost of heat exchanger 620 in the radial direction perpendicular to axis AX (See FIG. 7). One side of the channel 622 having the triangular-shape is defined by the outer rim 66. In so me embodiments, the diamond cross-sectional shape of the channels may be characterized by an angle A1, as shown in FIG. 8. The angle A1 may be greater than or equal to 20 degrees, 25 degrees, 30 degrees, 35 degrees, 40 degrees, and/or any other suitable angle. The angle A1 may also be less than or equal to 40 degrees, 35 degrees, 30 degrees, 25 degrees, 20 degrees, and/or any other suitable angle. Combinations of the foregoing ranges are also contemplated, including, but not limited to, angles between or equal to, 25 and 40 degrees, and bet ween 25 and 30 degrees. It should be appreciated that various through channels (e.g., channel 620 versus channel 622) may have different characteristic angles based on their radial position relative to axis AX (see FIG. 7). Of course, ang les less than or greater than the foregoing may also be employed, as the present disclosure is not limited by the angle of the diamond-shaped cross-section.

In some embodiments, the various channels 62 may also be characterized by a wall thickness T1, as shown in FIG. 8. The channel wall thickness may be determined by the processing conditions. For example, the roughness of the manufacturing method may determine the minimum possible wall thickness with said method. In some embodiments, the roughness of the manufacturing method may determine the geometry of the through channels. In some embodiments, the w all thickness T1 may be greater than or equal to 0.8 mm, 1 mm, 1.2 mm, 1.4 mm, 1.6 mm, 1.8 mm, 2 mm, 2.2 mm, 2.4 mm, 2.6 mm, 3 mm, and/or any other suitable thickness. The wall thickness T1 may also be less than or equal to 3 mm, 2.6 mm, 2.4 mm, 2.2 mm, 2 mm, 1.8 mm, 1.6 mm, 1.4 mm, 1.2 mm, 1 mm, 0.8 mm, and/or any other suitable thickness. Combinations of the fore going ranges are also contemplated, including, but not limited to, thicknesses be tween or equal to 1 mm and 2 mm, and between 0.8 mm and 3 mm, among others, are also contemplated. In some embodiments, the wall thickness T1 may be about 1 mm. Of course, wall thicknesses less than or greater than the foregoing may also be employed, as the present disclosure is not limited by the wall thickness.

In some embodiments, the operational Reynold's number of the heat exchanger, based on its geometry in combination with the material properties of the cooling fluid (e.g., air) and operating parameters of the flow of fluid through the s system, may be between 10,000 and 20,000 during operation to facilitate sufficient cooling of the system. Of course, the operational Reynold's number of the h cat exchangers described herein may be greater than 20,000 and/or less than 10,000 during operation, as the present disclosure is not limited to the Reynold's number of the heat exchanger.

In some embodiments, as shown in FIG. 8, a heat exchanger may include a variety of channels, each having a different cross-sectional area due to the radial arrangement of the channels. For example, the heat exchanger may have a channel 620, with the greatest cross-sectional area and a channel 622 with the smallest cross-sectional area of the system. The width of the channel 620 in circumferential direction around the axis AX is wider for the channel 620 located outs ide the radial direction perpendicular to the axis AX than for channel 620 located inside the radial direction. The width of the channel 620 in circumferential direction around the axis AX becomes wider as it is positioned radially outward in the radial direction. Table 1 below outlines various non-limiting geometric parameters of the two channel. Table 1 shows various geometric parameters for the smallest and largest channel cross-sections shown in FIG. 8:

TABLE 1

| Channel Geometry | Channel 622 | Channel 620 |
|---|---|---|
| Perimeter [mm] | 11.48 | 15.11 |
| Throughflow Area [mm²] | 7.35 | 14.24 |
| Hydraulic Diameter [mm] | 2.56 | 3.77 |
| r/ks (Smooth) [—] | 24.6 | 36.1 |
| r/ks (Rough) [—] | 7.54 | 11.1 |

In Table 1 above, r represents a hydraulic radius and ks represents a relative surface roughness of the channel. It should be appreciated that although Table 1 provides a range of parameters applicable to the heat exchanger of FIG. 8, values above and below those noted in the table may also be employed. It should be appreciated that achievable ranges of the geometric parameters of the heat exchanger channels (e.g., wall thickness, perimeter, etc.) may be determined by the manufacturing technique and resultant surface roughness. Accordingly, the r/ks parameter may be used to drive the channel geometry selection.

Table 2 below outlines several operational ranges of the two channels 620, 622 according to some embodiments. The ranges may be associated with a smooth channel surface, with a low surface roughness, or, alternatively, with a rough channel surface, with a higher surface roughness. Table 2 shows various non-limiting parameters for the smallest and largest channel cross-sections.

TABLE 2

| | ‘Smooth’ (350 Ra) | | ‘Rough’ (1140 Ra) | |
|---|---|---|---|---|
| Heat exchanger \dot{m} | 0.78 | | 0.75 | |
| at Flow Limit [kg/s] | | | | |
| Parameter at Flow | Channel | Channel | Channel | Channel |
| Limit | 622 | 620 | 622 | 620 |
| Inlet Velocity [m/s] | 77.5 | 97.3 | 69.5 | 87.9 |
| Inlet Re_{dH} [—] | 10200 | 18800 | 9100 | 17000 |
| Channel \dot{m} [g/s] | 0.467 | 1.12 | 0.446 | 1.09 |
| Channel \dot{Q} [W] | 15.6 | 23.0 | 15.6 | 25.0 |

In Table 2 above, Math. 2 represents the mass flow rate, Math. 3 represents rate of heat transfer, and Re_{dH} represents the hydraulic diameter-based Reynolds number, defined as Math. 4, where u is the channel throughflow velocity, du is the channel hydraulic diameter, and v is the kinematic viscosity of the cooling fluid (e.g., air). Although Table 2 provides a range of operational parameters applicable to the heat exchanger of FIG. 8, values above and below those noted in the table may also be employed.

$$\dot{m} \qquad [ Math . 2 ]$$

$$\dot{Q} \qquad [ Math . 3 ]$$

$${Re}_{dH} = \frac{{ud}_{H}}{v} \qquad [ Math . 4 ]$$

FIG. 9 shows a heat exchanger 60 coupled with a stator 51 of an electric ma chine, according to some embodiments. As noted previously, the heat exchanger 60 may be positioned directly inside the stator (radially inwards), with direct thermal and mechanical contact. For example, in some embodiments, a key 58 may be positioned in between an outer keyway (see keyway 65 in FIG. 7) of the heat exchanger 60 and an inner keyway (not shown) of the stator 51 to form an interference fit between the heat exchanger and the stator inner diameter (see surface 51A in FIG. 5A). In some embodiments, such an interference fit m ay provide additional resistance to rotational movement of the stator during operation to maintain the stator stationary relative to the system. In some embodiments, the keyways and key system may be designed with tolerances to accommodate thermal expansion of the stator relative to the heat exchanger. It should be appreciated that although two sets of keys and keyways are shown in FIG. 9, any number of keyways and keys may be employed to secure the stator to the heat exchanger, as the present disclosure is not so limited.

In some embodiments, the heat exchanger may remain stationary relative to the system through one or more mechanical couplings to the system. For example, in some embodiments, the inner surface of the heat exchanger diameter may be mechanically and thermally coupled to an outer surface of the spindle oriented towards the heat exchanger (see spindle 34B shown in FIG. 4). In such embodiments, a key may be positioned in between a keyway of the heat exchanger (see inner keyway 64 in FIG. 7) and a keyway of the spindle. Of course, other means of stabilizing the heat exchanger relative to the system are also contemplated.

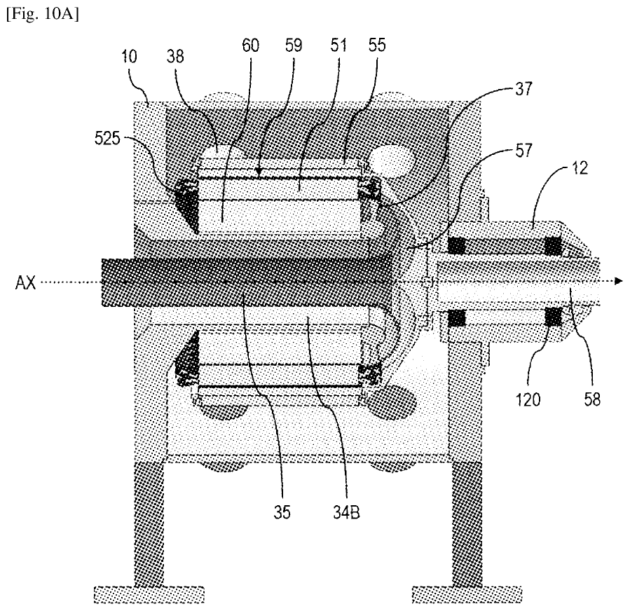

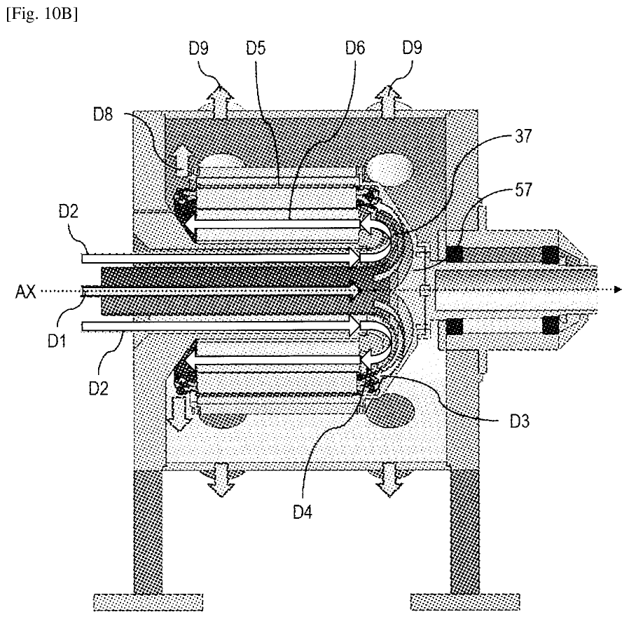

FIGS. 10A-10B depict a thermal management system for an electric machine according to some embodiments. As discussed previously, the electric machine m ay be cooled with fluid flowing through the system, absorbing heat generated from operation of the machine, and flowing out of the system as exhaust. In so me embodiments, two streams of fluid may flow through the system.

A first stream D1 of the two main streams may flow through an inlet (see in let 31 in FIG. 4), past an inlet valve (see inlet valve 15 in FIG. 4), and into a cooling tube (see cooling tube 32 in FIG. 4), and subsequently into flow separator tube 35, as shown in FIG. 10A. The fluid may flow through the tube in a direction substantially parallel to an axis AX towards an end bell flange 57, which may redirect stream D1 into stream D3, such that the fluid may flow towards an air gap 59 between the stator 51 and rotor 55. The fluid may therefore flow through the air gap 59 as stream D5, absorbing heat generated by the stator windings during operation. The flange 57 may serve to redirect stream D1 from a first direction parallel to axis AX to a second direction parallel to axis AX, shown as stream D5. In some embodiments, the curvature of the flange 57 serves to reverse the direction of fluid flow from the flow separator tube 35 to the air gap 59 In some embodiments, stream D5 may flow in between the stator teeth. It should be appreciated that the flow between streams D1, D3, and D5 may be radially symmetric about axis AX as shown in FIG. 10B. Fluid may then flow out of the air gap 59, through the end coils 525 of the stator (see FIG. 10A) to cool the end coils, and then flow towards the exhaust ports 38 in the form of an exhaust stream D9.

A second stream D2 of the two main streams may flow through a support tube inlet (see inlet 33A in FIG. 3), into a support tube (see tube 33 in FIG. 4), and subsequently into the radial space in between an outer surface of the flow separator tube 35 and spindle 34B, as shown in FIG. 10A. Stream D2 may flow along axis AX until it reaches end bell flange 37, at which point the fluid may turn according to the geometry of the flange 37 as stream D4 and flow to wards a heat exchanger 60 as stream D6. The flange 37 may serve to redirect stream D2 from a first direction parallel to axis AX to a second direction parallel to axis AX, shown as stream D6. In some embodiments, the curvature of the flange 37 serves to reverse the direction of fluid flow. Fluid in stream D6 may subsequently flow through the channels (see channels 62 in FIG. 7) of the h cat exchanger 60 as stream D6. Here, the fluid may absorb heat from the heat exchanger, which may itself be in thermal contact with the stator 51, absorbing heat generated by the windings during operation. Stream D6 may exit the heat exchanger 60 and absorb thermal energy from end coils 525 of the stator 51 as stream D8. Subsequently, stream D8 may flow towards exhaust ports 38 in the form of exhaust stream D9. In some embodiments, fluid from stream D5 and stream D6 may mix to form stream D8.

In some embodiments, at least a portion of the mixed stream D8 may flow in to the power electronics (see electronics 40 in FIG. 3) through one or more holes of a casing plate (see casing plate 34A) or other housing supporting the power electronics. In this way, the same fluid streams that transport heat away from the heat exchanger and the rotor stator air gap may also transport heat away from the power electronics. In such embodiments, fresh fluid may flow in thro ugh one or more vents (see vents 45 in FIG. 3), mixing with fluid flowing from stream D8 to cool the power electronics. Fluid may subsequently flow out of the power electronics casing towards vents (see vents 38 in FIG. 3) as exhaust fluid.

Streams D1 and D2 above may be introduced into the system from a fluid so urce either via suction into a fluid sink or via pumping from a fluid source. In some embodiments, fluid from the fluid source may be pumped into (e.g., thro ugh various inlets) and/or out of (e.g., through various outlets) of the system. Pressurized and/or actively induced flow may increase the flow rate of fluid (e.g., air) through the system, which may in turn increase the rate at which heat m ay be transported away from the system, compared to passive flow. It should be appreciated that fluid may be introduced into the system through any suitable means, including a combination of passive and actively induced flow. Fluid may flow into the system from one or more pressurized reservoirs and/or pumps. In some embodiments, the cooling fluid may be routed from bleed air from the low-pressure, or high-pressure compressor of an acroengine. Other embodiments of an external fluid source are also contemplated. In some embodiments, the flu id flowing as streams D1 and D2 may be air, although other thermally conductive fluids are also contemplated.

As discussed earlier, the broad variety of operational parameters of the system, in addition to the complexity of relationships in between said parameters, presents major challenges for determining specific combinations for providing high specific power and efficiency designs. Identifying feasible operational parameter ranges to achieve greater specific powers than conventionally achievable can be a difficult endeavor. In some embodiments, operational power ranges for high specific power and efficiency designs may be identified using a multigrid parameter search sweeping the following parameters: (1) rotational speed of the rotor r elative to the stationary stator, (2) average electromagnetic shear stress in between the rotor and the stator, (3) aspect ratio of rotor and stator assembly length (see length L1 in FIG. 5B) to air gap radius (see radius R1 in FIG. 5A), hereinafter referred to as length-to-tip-radius aspect ratio (4) number of stator pole p airs, (5) stator slot current density, (6) air gap thickness (see thickness G1 in FIG. 5A), (7) nondimensional magnet thickness, defined as the magnet thickness (see thickness G1 in FIG. 5A) divided by a maximum magnetic thickness possible under the structural loading constraints (e.g., the load-bearing rotor element containing the rotor magnets at the maximum speed which may have a structural safety factor of at least 2), and (8) switching frequency of the power electronics.

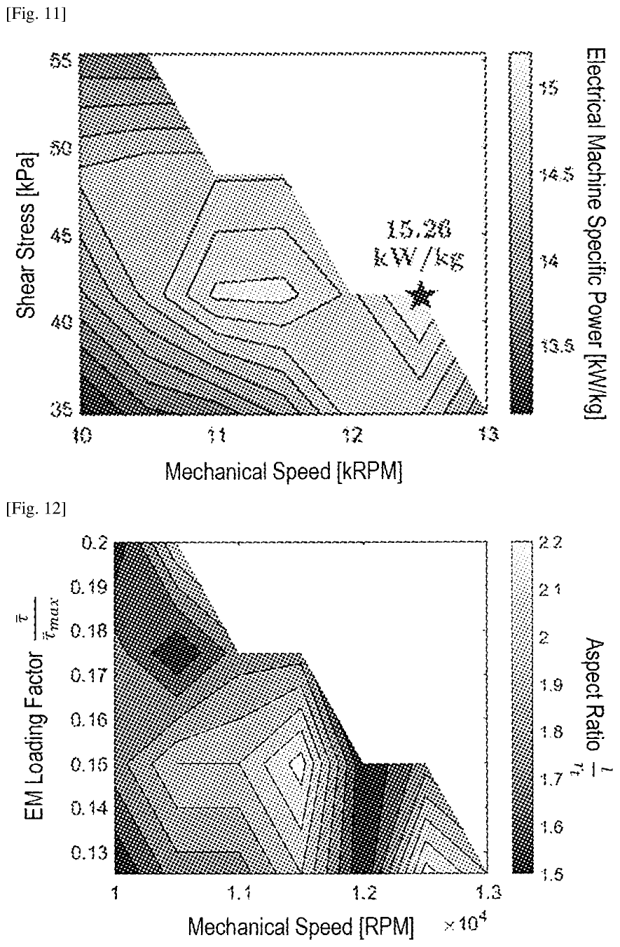

In some embodiments, this large eight-dimensional parameter space may be collapsed to rotational speed and shear stress to identify areas of the design space with promising high specific power/high efficiency machines. FIG. 11 shows an exemplary plot of an overall demonstrator performance as a function of these two parameters for a specific system embodiment similar to that described above relative to the figures. It should be appreciated that some embodiments of the exemplary performance analyses described herein may not include the mass of the supporting frame. As will be described in greater detail below, analyses including the supporting frame mass are also contemplated. The white space shown in this contour plot represents the infeasible regime of parameters due to construction limitations or safe operation limits. FIG. 11 shows an optimal specific power of 15.26 kW/kg, which may be modified via a combination of parameter variation and 2D finite element analysis to realize a feasible design that did not have magnetic saturation in the stator back iron. Reaching saturation in the stator back iron may generate higher order harmonics and therefore introduce additional losses into the system. In some embodiments, an electric machine design may achieve a specific power of 16.5 kW/kg, using an active element mass comprising the stator, windings, permanent magnets, retaining sleeve, and heat ex changer. In some embodiments, the calculated specific power may incorporate losses including, but not limited to, stator core loss, windage loss, winding loss (fundamental and/or proximity/skin effect losses), permanent magnet eddy current loss, and pulse width modulation-generated losses. Table 3 below outlines non-limiting parameters associated with the modified optimal specific power for this one exemplary embodiment. Table 3 shows non-limiting input parameters for a design achieving a specific power of 16.5 kW/kg:

TABLE 3

| Parameter | Value |
|---|---|
| Specific Power [kW/kg] | 16.5 |
| Rated Power [MW] | 1 |
| Angular Speed [RPM] | 12500 |
| Torque [Nm] | 764 |
| Shear Stress [kPa, psi] | 34.9, 5.0 |
| Slot Current Density [Aₚₑₐₖ/mm²] | 13.3 |
| Number of Pole Pairs | 10 |
| Air Gap Thickness [mm] | 3 |
| Length-to-Tip Radius Aspect Ratio [—] | 1.54 |
| Number of Turns [—] | 10 |

It should be appreciated that the design outlined by Table 3 includes certain measures of conservatism that may not be assumed in other designs. For example, the core losses may be doubled from that stated by the manufacturer, the winding hotspot temperature may be limited to 180° C., the stator slot flux densities may be limited to 2.1 T, the rotor retaining sleeve (see sleeve 56 in FIG. 5A), which may be formed of titanium, may be sized such that stresses are less than or equal to half the titanium yield stress, and the bearing inner diameter may be large enough such that at least an additional 30% cooling air mass flow may be passed. In some embodiments, a scaling law for a simple electric machine model may state that the power per unit rotor volume (approximately specific power) scales as the following Math. 5:

$$\frac{P}{V} = 2 {( \overline{τ} )}^{3 / 2} \sqrt{\frac{2 π ( \frac{l}{r} ) {U}^{3}}{P}} \qquad [ Math . 5 ]$$

where P is the rated power, V is the rotor volume, Math. 6 is the average electromagnetic shear stress between the rotor and the stator, l/r is the length-to-tip radius aspect ratio, and U is the air gap speed, defined as the product of the rotational speed of the rotor and an air gap radius (e.g., air gap radius R1 in FIG. 5A). Using this scaling law, parameters for the highest specific power designs at each shear stress and rotational speed point, which drive electric machine specific power, are shown in FIGS. 12-16 and provide ranges on the controlling parameters.

$$\overline{τ} \qquad [ Math . 6 ]$$

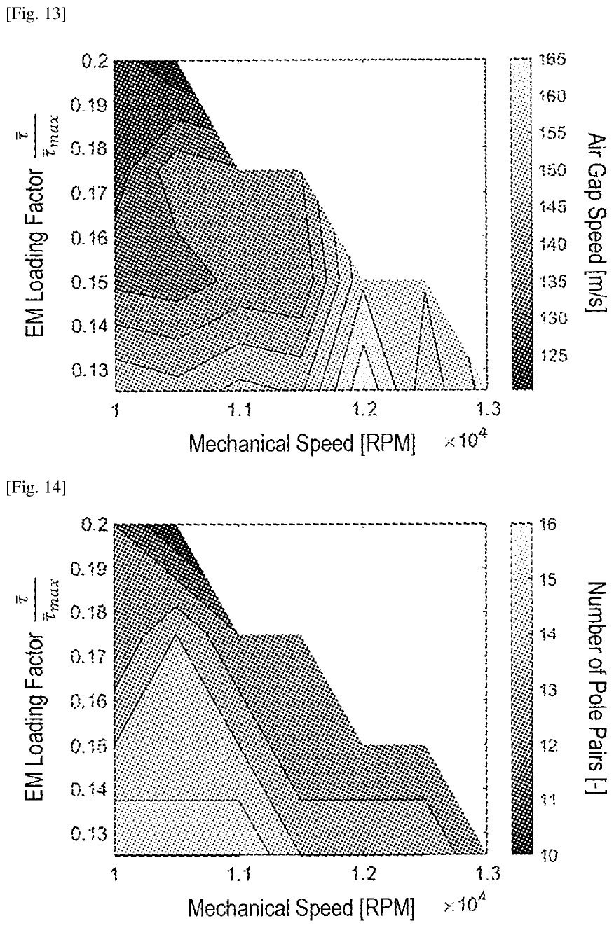

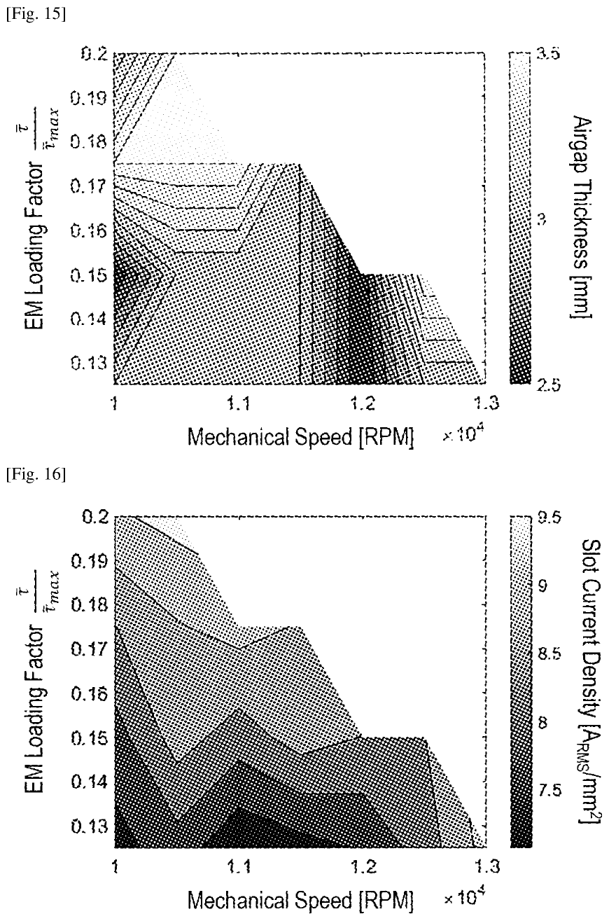

FIG. 12 shows a plot of length-to-tip aspect ratio as a function of mechanical speed and electromagnetic loading factor for an electric machine according to some embodiments. As described previously, the electromagnetic loading factor may be defined as the electromagnetic shear stress within the air gap divided by the core saturation flux density-limited value, τₘₐₓ is shown in the following Math. 7:
where B_{c} represents the material saturation flux density and μ₀ is the permeability of free space. As shown in FIG. 12, the length-to-tip radius aspect ratio may be optimized to 1.5 or greater for all high specific power designs investigated. The white space shown in all contour plots represents the infeasible regime of parameters due to construction limitations or safe operation limits. FIG. 13 shows a plot of air gap speed as a function of mechanical speed and electromagnetic loading factor according to some embodiments. As shown, the air gap speed may be optimized to 120 m/s or greater for all high specific power designs investigated. FIG. 14 shows a plot of number of pole pairs as a function of mechanical speed and electromagnetic loading factor according to some embodiments. As shown, the number of pole pairs may be optimized to 10 poles or greater for all high specific power designs investigated. FIG. 15 shows a plot of air gap thickness as a function of mechanical speed and electromagnetic loading fac tor according to some embodiments. As shown, the air gap thickness may be optimized between 2.5 mm and 3.5 mm for all high specific power designs investigated. In some embodiments, smaller air gap thicknesses such as 2 mm may be conceivable if the core loss is lower than the assumed safety factor of two. Lastly, FIG. 16 shows a plot of slot current density as a function of mechanical speed and electromagnetic loading factor for an electric machine according to some embodiments. As shown, the slot current density may be optimized to at least 7 ARMS/mm2 for all high specific power designs investigated.

$${τ}_{max} = \frac{{B}_{c}^{2}}{16 {μ}_{0}} \qquad [ Math . 7 ]$$

In some embodiments, non-limiting parameter ranges for various designs may be established by the scaling law outlined previously as well as the co-optimization sweeps shown in FIGS. 12-16, organized in Table 4 below. Table 4 shows non-limiting operational parameter ranges for various designs:

TABLE 4

| Parameter | Range |
|---|---|
| Electric Machine Specific Power [kW/kg] | >16.5 |
| Electromagnetic Shear Stress [kPa, psi] | >34.9, >5.0 |
| Rotational Speed [RPM] | >10,000 |
| Length-to-Tip Radius Aspect Ratio [—] | >1.5 |
| Air Gap Speed [m/s] | >120 |
| Number of Pole Pairs [—] | >10 |
| Slot Current Density [A_{RMS}/mm²] | >7 |

It should be appreciated that one of the design constraints of a system may be the hotspot temperature of the conductive windings of the stator. In some embodiments, the hotspot temperature limit may be 180° C., corresponding to class H insulation. However, it should be appreciated that it may be feasible to use greater hotspot temperatures which would push the parameters listed in Table 4 to greater values as indicated in the table.

Through the various experiments and modeling done by the current inventors, the below operating parameters have been identified as being associated with high specific power for the disclosed electric machine designs. Accordingly, these parameters may be combined with one another, and the various electric machi ne designs disclosed herein, to provide an electric machine with a desired combination of operating space and performance. Depending on the embodiment, it should be understood that these parameters may either be used in concert with one another, individually, and/or in any desired combination as the current disclosure is not limited in this fashion.

In some embodiments, it may be desirable to provide high specific powers bet ween, for example, 10-20 kW/kg for systems including an electric machine, power electronics, frame, and a thermal management system, such as in megawatt power applications. The high specific power achieved by the systems described herein may perform at greater than or equal to 10 kW/kg, 12 kW/kg, 15 kW/k g, 17 kW/kg, 20 kW/kg, and/or any other suitable specific power. The systems described herein may also perform at specific powers including, but not limited to, less than or equal to 20 kW/kg, 17 kW/kg, 15 kW/kg, 12 kW/kg, 10 kW/kg, and/or any other suitable specific power. Combinations of the foregoing ranges, including specific powers between or equal to 10 kW/kg and 20 kW/kg, 13 kW/kg and 25 kW/kg, and 10 kW/kg and 25 kW/kg, among others may also be employed. It should be appreciated that specific powers greater than or less than the foregoing may also be employed.

It should be appreciated that various combinations of components described herein (e.g., electrical machine, thermal management system, etc.) may operate at any suitable specific power ranges dependent upon the components employed. F or example, a system of an electric machine, power electronics, and a thermal management system (including a heat exchanger, in some exemplary embodiments) may operate between 10 kW/kg and 25 kW/kg, whereas a subsystem of the electric machine and the heat exchanger may be larger, given the lower mass compared to the overall system. Accordingly, it should be appreciated that the various components and combinations of components described herein may perform at any suitable specific power.

In some embodiments, the systems described herein may experience electromagnetic shear stresses between the rotor and the stator during operation. The electromagnetic shear stress may be greater than 35 kPa (or 5 psi). In some embodiments, the electromagnetic shear stress may be greater than or equal to 20 kPa, 35 kPa, 40 kPa, 50 kPa, 60 kPa, 80 kPa, and/or any other suitable value during operation. The electromagnetic shear stress may also be less than or equal to 80 kPa, 60 kPa, 50 kPa, 40 kPa, 35 kPa, 20 kPa, and/or any other suitable value. Combinations of the foregoing, including electromagnetic shear stresses be tween 20 kPa and 80 kPa during operation are also contemplated. It should be appreciated that the systems described herein may experience any suitable electromagnetic shear stresses between the rotor and the stator above and below the aforementioned ranges, as the present disclosure is not so limited.

To achieve high specific powers, in some embodiments, the systems described herein may operate at an electromagnetic loading factor of greater than or equal to 0.05, 0.1, 0.2, 0.3, 0.4, 0.5, 0.6, 0.7, and/or any other suitable loading factor. The electromagnetic loading factor may also be less than or equal to 0.7, 0.6, 0.5, 0.4, 0.3, 0.2, 0.1, 0.05, and/or any other suitable loading factor. Combinations of the foregoing, including but not limited to, electromagnetic loading factors between or equal to 0.05 and 0.7 and/or 0.2 and 0.4, among others, are also contemplated. In some embodiments, the electromagnetic loading factor may more preferably be between 0.25-0.35. It should be appreciated that the systems herein may operate at any suitable electromagnetic loading factor and/or ranges of suitable electromagnetic loading factors, as the present disclosure is not so limited.

To achieve high specific powers, in some embodiments, the systems described herein may operate at mean rotor velocities greater than 120 m/s relative to the stator. In some embodiments, the mean rotor velocity may be greater than or equal to, 120 m/s, 150 m/s, 190 m/s, 200 m/s, 220 m/s, 250 m/s, 270 m/s, 300 m/s, and/or any other speed. The mean rotor velocity may also be less than or equal to, 300 m/s, 270 m/s, 250 m/s, 220 m/s, 200 m/s, 190 m/s, 150 m/s, 120 m/s, and/or any other speed. Combinations of the foregoing, including me an rotor velocities between 120 m/s and 300 m/s, and/or any other speeds are also contemplated.

In some embodiments, the systems described herein may operate at mechanical speeds of greater than or equal to 3 kRPM, 5 kRPM, 7 kRPM, 9 kRPM, 11 kRPM, 13 kRPM, 15 kRPM, 17 kRPM, 19 kRPM, and/or any other suitable speed. The mechanical speeds may also be less than or equal to 19 kRPM, 17 k RPM, 15 kRPM, 13 kRPM, 11 kRPM, 9 kRPM, 7 kRPM, 5 kRPM, 3 kRPM, and/or any other suitable speed. Combinations of the foregoing, including, but not limited to mechanical speeds between or equal to 3 kRPM to 19 kRPM, 9 k RPM and 15 kRPM, among others are also contemplated. In some embodiments, the mechanical speed may more preferably be between 11 kRPM and 13 kRPM. It should be appreciated that the systems herein may operate at any suitable mechanical speeds and/or ranges of suitable mechanical speeds, as the present disclosure is not so limited.

To achieve high specific powers, in some embodiments, the systems described herein may operate at electrical frequencies of greater than or equal to 1000 Hz, 1200 Hz, 1500 Hz, 1700 Hz, 1900 Hz, 2000 Hz, 2100 Hz, 2300 Hz, 2500 Hz, 2700 Hz, 3000 Hz, 3200 Hz, and/or any other suitable electrical frequency. The systems may also operate at electrical frequencies of less than or equal to 3200 Hz, 3000 Hz, 2700 Hz, 2500 Hz, 2300 Hz, 2100 Hz, 2000 Hz, 1900 Hz, 1700 Hz, 1500 Hz, 1200 Hz, 1000 Hz, and/or any other suitable electrical frequency. Combinations of the foregoing, including, but not limited to electrical frequencies between or equal to 1000 Hz and 3200 Hz, 1500 Hz and 3000 Hz, among others are also contemplated. In some embodiments, the electrical frequency may more preferably be between 1900 Hz and 2100 Hz. It should be appreciated that the systems herein may operate at any suitable electrical frequencies and/or ranges of suitable electrical frequencies, as the present disclosure is not so limited.

To achieve high specific powers, in some embodiments, the power electronics of the systems described herein may operate at switching frequencies of greater than or equal to 20 kHz, 40 kHz, 60 kHz, 80 kHz, 100 kHz, 120 kHz, 150 kHz, and/or any other suitable frequencies. The switching frequency of the pow er electronics described herein may also be less than or equal to, 150 kHz, 120 kHz, 100 kHz, 80 kHz, 60 kHz, 40 kHz, 20 kHz, and/or any other suitable frequencies. Combinations of the foregoing, including, but not limited to, between or equal to 20 kHz and 150 kHz, 40 kHz and 120 kHz, among others are also contemplated. In some embodiments, the switching frequency of the power electronics may more preferably be between 60 kHz and 80 kHz. It should be appreciated that the power electronics described herein may operate at any suitable switching frequencies and/or ranges of suitable switching frequencies, as the present disclosure is not so limited.

To achieve high specific powers, in some embodiments, the systems described herein may employ a length-to-tip radius aspect ratio of greater than or equal to 1, 1.2, 1.5, 1.8, 2, 2.2, 2.5, 2.7, 3, and/or any other suitable aspect ratio. The systems may also employ length-to-tip radius aspect ratios less than or equal to 3, 2.7, 2.5, 2.2, 2, 1.8, 1.5, 1.2, 1, and/or any other suitable aspect ratio. Combinations of the foregoing ranges, including, but not limited, length-to-tip radius aspect ratios between, or equal to, 1 to 3, 1.2 to 2.7, among others, are contemplated. In some embodiments, the length-to-tip radius aspect ratio may more preferably be between 1.8 and 2.2. It should be appreciated that the systems de scribed herein may employ any suitable length-to-tip radius aspect ratios and/or ranges of suitable length-to-tip radius aspect ratios, as the present disclosure is not so limited.

To achieve high specific powers, in some embodiments, the systems described herein may employ a nondimensional magnet thickness of greater than or equal to 0.1, 0.2, 0.3, 0.4, 0.5, 0.6, 0.7, 1, and/or any other nondimensional magnet thickness. The nondimensional magnet thickness may also be less than or equal to 1, 0.7, 0.6, 0.5, 0.4, 0.3, 0.2, 0.1, and/or any other nondimensional magnet thickness. Combinations of the foregoing ranges, including, but not limited to, nondimensional magnet thicknesses between or equal to 0.1 to 1, 0.2 to 0.7, among others are also contemplated. In some embodiments, the nondimensional magnet thickness may more preferably be between 0.3 and 0.5. It should be appreciated that the systems described herein may employ any suitable nondimensional magnet thickness and/or ranges of nondimensional magnet thicknesses, as the present disclosure is not so limited.

To achieve high specific powers, in some embodiments, the systems described herein may employ a slot current density of greater than or equal to 5 ARMS/mm2, 7 ARMS/mm2, 9 ARMS/mm2, 11 ARMS/mm2, 13 ARMS/mm2, 15 AR MS/mm2, 17 ARMS/mm2, 19 ARMS/mm2, and/or any other suitable current density. The slot current density may also be less than or equal to 19 ARMS/mm 2, 17 ARMS/mm2, 15 ARMS/mm2, 13 ARMS/mm2, 11 ARMS/mm2, 9 ARMS/mm2, 7 ARMS/mm2, 5 ARMS/mm2, and/or any other suitable current density.

Combinations of the foregoing, including, but not limited to, slot current densities between or equal to 5 ARMS/mm2 to 19 ARMS/mm2, 7 ARMS/mm2 to 17 ARMS/mm2, among others are also contemplated. In some embodiments, slot current densities may more preferably be between 11 ARMS/mm2 and 13 ARMS/mm2. It should be appreciated any suitable slot current density and/or combinations of slot current densities may be employed, as the present disclosure is not so limited.

To achieve high specific powers, in some embodiments, the systems described herein may employ any suitable air gap thickness in between the rotor and the stator and/or combinations of suitable air gap thicknesses, as discussed previously in relation to FIG. 5A.

To achieve high specific powers, any combination of one or more of the aforementioned operational parameters may be employed, as detailed in Table 5 bel ow. Table 5 shows non-limiting operational parameter ranges for high specific p ower designs:

TABLE 5

| Parameter | Range |
|---|---|
| Electromagnetic Loading Factor [—] | 0.25-0.35 |
| Mechanical Speed [kRPM] | 11-13 |
| Electrical Frequency [Hz] | 1900-2100 |
| Power Electronics Switching Frequency [kHz] | 60-80 |
| Length-to-Tip Radius Aspect Ratio [—] | 1.8-2.2 |
| Nondimensional Magnet Thickness [—] | 0.3-0.5 |
| Slot Current Density [A_{RMS}/mm²] | 11-13 |
| Air gap thickness [mm] | 2.5-3.5 |

In some embodiments, the electrical frequency fₑ and mechanical speeds 22 recited in Table 5 may determine the number of poles Np shown in the following Math 8:

$${f}_{e} = \frac{{N}_{p}}{2} Ω \qquad [ Math . 8 ]$$

It should be appreciated that increasing the number of poles may reduce the thickness of the rotor, and therefore reduce the overall mass of the rotor. However, as noted by the relationship between electrical frequency and pole numbers, increasing the number of poles may also increase the electrical frequency and magnet-to-magnet flux leakage of the rotor. Increasing electrical frequency, in turn, may increase core losses, proximity and skin effect losses in the windings of the stator, and permanent magnet losses. Thus, determining the number of poles may include a trade-off between mass and efficiency (e.g., relative to losses)

It should be appreciated that systems described herein may employ any combi nation of the aforementioned ranges and those detailed in Table 5. For example, in some embodiments, the system may operate at mechanical speeds and air g ap thicknesses within range of those detailed in Table 5, but may operate at electrical frequencies below or above those detailed in Table 5. Accordingly, embodiments described herein may employ one or more operational parameters at the ranges detailed in Table 5 in any combination. Of course, embodiments opera ting at none of the parameter ranges detailed in Table 5 are also contemplated. The systems described herein may not operate at each of the parameter ranges detailed in Table 5.

It should be appreciated that the systems described herein may be implemented and controlled in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (P DA), a smart phone, tablet, or any other suitable portable or fixed electronic de vice.

Also, a computing device may have one or more input and output devices. These devices can be used, among other things, to present a user interface. Examples of output devices that can be used to provide a user interface include display screens for visual presentation of output and speakers or other sound gen crating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtu machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored there on can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that c an be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the p resent invention. More generally, those skilled in the art will readily appreciate that all parameters, dimensions, materials, and configurations described herein a re meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments a re presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A system comprising:
a frame;
a stator
a rotor electromagnetically coupled to the stator, the stator disposed at least partially within the rotor; and
a heat exchanger operatively coupling the stator with the frame, wherein the heat exchanger maintains the stator substantially stationary relative to the frame, and wherein the heat exchanger is in thermal communication with the stator.

2. The system according to claim 1, wherein the heat exchanger is disposed radially inward relative to the stator.

3. The system according to claim 1, wherein the heat exchanger comprises a plurality of through channels extending along a length of the heat exchanger.

4. The system according to claim 3, wherein the plurality of through channels extend parallel to a longitudinal axis of the stator.

5. The system according to claim 3, wherein the plurality of through channels are arranged in a diamond lattice along a cross-section of the heat exchanger normal to a longitudinal axis of the stator.

6. The system according to claim 5, wherein a characteristic angle of the diamond lattice is between 25 and 30 degrees.

7. The system according to claim 3, wherein the through channel in circumferential direction around a longitudinal axis of the stator is wider for the through channel located outside a radial direction perpendicular to the longitudinal axis than for the through channel located inside the radial direction.

8. The system according to claim 7, wherein the width of the through channel in the circumferential direction around the longitudinal axis becomes wider as it is positioned radially outward in the radial direction.

9. The system according to claim 1, wherein the heat exchanger and the stator are coupled with an interference fit.

10. The system according to claim 1, further comprising at least one flange in fluid communication with the heat exchanger, the at least one flange comprising a curved surface configured to reverse a direction of fluid flow relative to a longitudinal axis of the stator.

11. The system according to claim 1, wherein a specific power of an assembly of the rotor and the stator is between 13 and 25 kW/kg during operation.

12. The system according to claim 1, wherein the rotor is configured to rotate at least at 10,000 RPM relative to the stator.

13. The system according to claim 1, wherein the stator comprises a tooth-and-slot core.

14. The system according to claim 13, wherein the tooth-and-slot core is formed of a plurality of lamination layers, wherein each of the plurality of the lamination layers is 4 mil thick.

15. A method of operating an electric machine, the method comprising:
maintaining a stator substantially stationary relative to a frame with a heat exchanger, the heat exchanger operatively coupled to the stator, the heat exchanger operatively coupled to the frame; and
transporting thermal energy from the stator to the heat exchanger, the stator electromagnetically coupled to a rotor, the stator disposed at least partially within the rotor.

16. The method according to claim 15, further comprising positioning the heat exchanger radially inward relative to the stator.

17. The method according to claim 15, further comprising flowing a fluid through a plurality of through channels extending along a length of the heat exchanger.

18. The method according to claim 15, further comprising flowing a fluid through an air gap in between the rotor and the stator.

19. The method according to claim 15, further comprising coupling the heat exchanger and the stator with an interference fit.

20. The method of claim 15, further comprising operating the electric machine at a specific power between 13 and 25 kW/kg during operation.

21. The method of claim 15, further comprising rotating the rotor at least at 190 m/s relative to the stator.

22. The method of claim 15, further comprising rotationally coupling the stator and the heat exchanger with a key positioned in a key way of the stator.
